(19) United States
(12) Patent Application Publication
(10) Pub. No.: US 2013/0144756 A1
(43) Pub. Date: Jun. 6, 2013

(54) TRANSACTION SYSTEM

(71) Applicants: Juan Farrarons, London (GB); George Karibian, London (GB); Thomas E. Lahey, Manchester (GB)

(72) Inventors: Juan Farrarons, London (GB); George Karibian, London (GB); Thomas E. Lahey, Manchester (GB)

(21) Appl. No.: 13/310,166

(22) Filed: Dec. 2, 2011

(51) Int. Cl. G06Q 30/06

(52) U.S. Cl. 705/26.41

(57) ABSTRACT

A transaction system is disclosed comprising a plurality of merchant devices, a plurality of customer devices and a central payment system, whereby any of the customers can conduct financial transactions with any of the merchants by means of, after an initial registration, entry of a unique ID associated with the merchant, password, payment amount and the system recognition of the customer's mobile phone number CLI. The system is particularly useful for enabling small value merchant or merchants to easily conduct transactions face to face with customers.

### FIELD OF THE INVENTION

This invention relates to a transaction system. In particular, it relates to a transaction system for enabling face-to-face card payment acceptance for merchants using any mobile device.

### BACKGROUND

A great many businesses and merchants around the world choose not to accept payments by credit, debit or other payment cards due to the costs of point of sale (PoS) terminals and the expense and effort of managing the necessary PoS infrastructure to process payments. This is particularly the case for small to medium businesses (SMB), micro merchants, businesses in the emerging markets and highly mobile businesses.

Presently, the only alternative methods of accepting payment for such merchants are cash, cheques and bank transfer. Each of these have there own problems. If the merchant is a market trader, for example, their potential customer may not have sufficient cash on his person to buy a particular item or have a cheque book. Indeed, the traditional cheque payment system is being phased out in many areas. A bank transfer technique is also completely inappropriate for a customer buying a low value item from a small trader such as a market trader.

There is a need for an alternative method of accepting card payments which is convenient, can be set up instantly or very quickly, is mobile in that a user does not have to be at a particular location to use it, can be used by any consumer and that has low set up and maintenance costs making it viable for a merchant having a relatively low turnover.

### SUMMARY OF THE INVENTION

According to the present invention in a first aspect there is provided a transaction system comprising a payment platform provided on a network, the platform comprising; means for transmitting data to and from a plurality of merchant-side terminals; means for transmitting data to and from a plurality of customer-side terminals; and means for providing data to and from one or more financial institutions; wherein each merchant is associated with a unique reference and comprising means for a customer mobile telephone number, a password and a merchant unique reference to be input to the service provider from a merchant terminal and/or a customer terminal and, if the mobile number is logged against a source of funds provided by one or more of the financial institutions, enabling a transaction to be authorised and money transferred from the financial institution to the merchant.

The customer-side and/or merchant side terminals may be mobile devices connectable to a network, such as mobile (cell) phones, tablets, PDAs, laptop or other computers for example.

The telephone number (otherwise known as calling line identifier (CLI) is preferably picked up automatically since this is transmitted by the mobile terminal. It may instead be input by a user.

In a further aspect, there is provided a method for conducting transactions between one of a plurality of merchants and one of a plurality of customers, comprising, at a payment system remote from the merchants and customers, storing data related to a customer against a record relating to a customer's mobile telephone number and enabling a transaction to be completed upon input of a password, payment amount and a unique identifier, in addition to recognition of said telephone number, the calling line identifier (CLI), or input thereof, for the merchant to thereby enable said transaction.

The card details or related to the customer is preferably a token, unless possibly it is the customers' first transaction on the network or they have not transacted on the network in a long time, such as a predetermined time period. This may be any length of time chosen by a service provider.

The invention further provides a transaction system comprising a plurality of merchant devices, a plurality of customer devices and a central payment system, whereby any of the customers can conduct financial transactions with any of the merchants by means of, after an initial registration, entry of a unique ID associated with the merchant, a password, and payment amount in addition to the recognition by the system of the customer's mobile phone number CLI.

Embodiments of the present invention enable a large number of merchants to accept card payments from a large number of consumers using even the most basic type of mobile telephone on both ends of a transaction (ie merchant and consumer).

Embodiments of the invention enable traditional point of sale terminals to be replaced by simple telephones, which may be smart phones and may incorporate specific smart phone applications (or apps) such as ‘apps’ available on the Apple™ store, Android™ store or others or may be basic telephones having simple voice and/or SMS capabilities.

Embodiments enable merchants to reach a larger share of customers by offering a universally accepted payment facility as an alternative to cash, cheques, and so on.

By the use of embodiments of the invention, it is possible for a merchant to set up a facility to accept card payments within a very short time period, perhaps hours or even less, rather than weeks as is necessary with present systems.

In addition, set up and ongoing fixed costs are minimal compared to traditional POS (point of sale) devices. This enables merchants, particularly very small merchants such as market traders, persons working from home on a small scale, or others, to be able to accept credit card payments, possibly for the first time. Then greatly increase their turnover and ease with which customers can purchase goods or services from them.

Embodiments of the invention will now be described, by way of example only, with reference to the accompanying drawings, in which:

### DESCRIPTION OF THE DRAWINGS

FIG. 1 shows schematically a transaction system;

FIG. 2 shows a system in a little more detail;

FIG. 3 shows a process by which a merchant can initially set up a credit or debit card handling system;

FIG. 4 shows an initial registration processing for a consumer/customers;

FIG. 5 shows a transaction process;

FIG. 6 shows a fraud detection process;

FIG. 7 shows an SMS transaction process; and

FIG. 8 shows an interface enabling consumers and/or merchants to review, maintain or otherwise service their account.

### DESCRIPTION OF PREFERRED EMBODIMENTS OF THE INVENTION

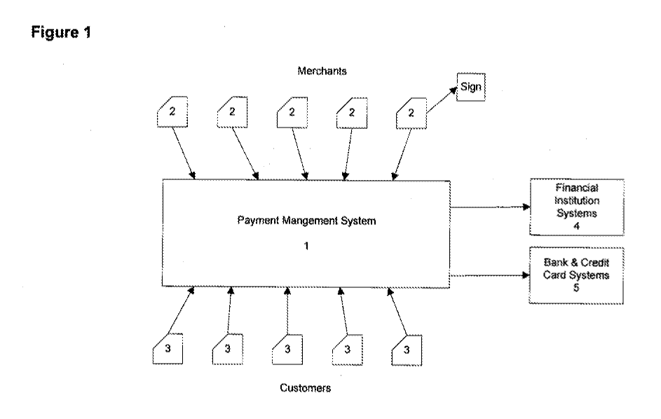

FIG. 1 shows schematically a transaction system. This comprises a central payment platform or payment management system 1 which may comprise one or more data servers, storage means, processing means and so on and may be located at any point, or distributed over, a network such as the Internet. A plurality of merchants each have a mobile device or terminal 2, which may be as simple as a basic mobile telephone, a smart phone, a portable device such as a tablet or any other device capable of connecting to the Internet or other network. A plurality of consumers also each have their own mobile device 3 which again can also connect to the service provider's payment management system 1.

The connection of any of the devices 2 and 3 is principally via IVR (Interactive Voice Response). through touch tone keys or voice and may also be via the Internet and/or via a mobile communication system such as SMS, 3G system, UMTS, GSM, Wi-Fi or any other system for connecting a mobile device.

The payment management system 1 can also connect to one or more financial institutions systems 4, 5 such as a bank, credit card company, and so on in order to authenticate and determine customer accounts and to enable financial transactions to be conducted between any of the merchants 2 and the customer 3 using the customers accounts at the relevant financial institution(s).

The following is a brief summary of how card acceptance may be provided to merchants via some embodiments of the invention.

Merchants wishing to accept payments by a credit and debit card open a merchant account through the payment managing system 1. This will be generally operated by a service provider who will, in one business model, typically take a small percentage of each card transaction and perhaps also charge set-up or other fees. The system 1 associates each particular unique merchant's account with a unique merchant ID (such an ID number or other alphanumeric code for example) and provides the merchant with this ID. This may be an 8 digit number in some embodiments but may be otherwise.

This may be provided on a sign, typically a rigid board made of plastics or other material which the merchant can display at their place of business or temporary location, eg the location of their market stall or otherwise, and bears the merchant's ID number. This can also bear other information of course such as the merchant's name, address, access telephone number to use the service, helpline numbers and so on. The sign may be provided by the service provider or by the merchant themselves. This sign is therefore displayed by the merchant to customers and also includes instructions on how to make payments through their mobile devices such as mobile phones.

When a customer makes their first transaction, they register their details on the payment management system, typically through a mechanism such as interactive voice response (IVR) using the keys (real keys or virtual keys on a touch screen device for example) on their phone.

Instead of calling the merchant, the customer calls a centralised IVR phone number maintained by the payment management system and details of which are provided on the sign. They enter the merchant ID.

The customer then proceeds to enter their card detail on the system using the keys (or touch screen) of the device, followed by authentication details. These authentication details may comprise, in certain embodiments, the CVV or CV2 (customer verification) number which is always provided on the rear of a credit card. All other password means may be provided. Instead of key input, voice input may be used.

Finally, the customer enters the purchase amount and may optionally then confirm the transaction.

The steps above need not be done in the particular order specified.

The transaction is then authenticated through the platform.

For repeat purchases, after a customer has already made one purchase and registered his details, the customers make payment by simply entering the merchant's ID, the purchase amount and the authentication details. This transaction is then authorised through the payment management system, which already stores customer details, including cardholder details in tokenized form, and confirmation messages are sent to both the merchant, via their device 2, and the customer, via their device 3, to confirm payment.

Once payment has been made then the merchant releases the goods or performs the relevant service for the customer.

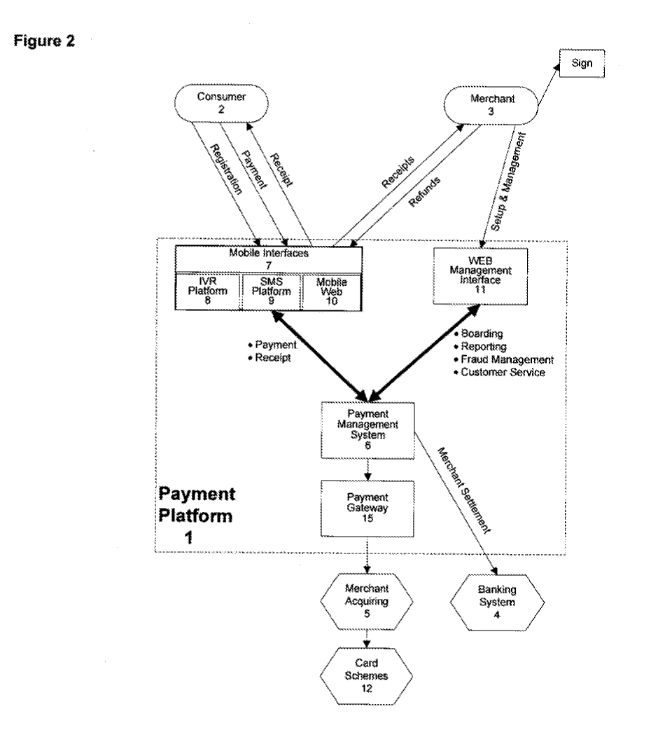

FIG. 2 shows a payment platform in a little more detail. The payment management system 1 includes a basic payment management system functionality 6 which will generally include server means, processing means, memory means and/or similar functionality. It includes one or more mobile interfaces 7 which may comprise an IVR (interactive voice response) platform 8, an SMS (text message) platform 9 and/or a mobile web interface 10 for example. Other interfaces may be used as appropriate. These enable the payment management system 6 to communicate with external devices such as the consumer's devices (phone) 2 or the merchants devices (phone) 3. The communication with each is two-way as shown so that registration details, payment details and receipts can be passed to and from the consumer and receives perhaps also refunds to and from the merchant. The payment management system also includes a web management interface 11 which may enable a merchant and/or a consumer to manage, view and service their account, as is described in more detail below.

Furthermore, the payment management system includes a payment gateway 15 which is generally software having functionality for communicating, over a suitable communication link, with financial institutions 4, 5 (FIG. 1). For example, it can communicate with a banking system 4 or with a merchant acquiring system 5 and through this to various card schemes 12. Clearly, security is important and various levels of encryption will be used as is well known in the art.

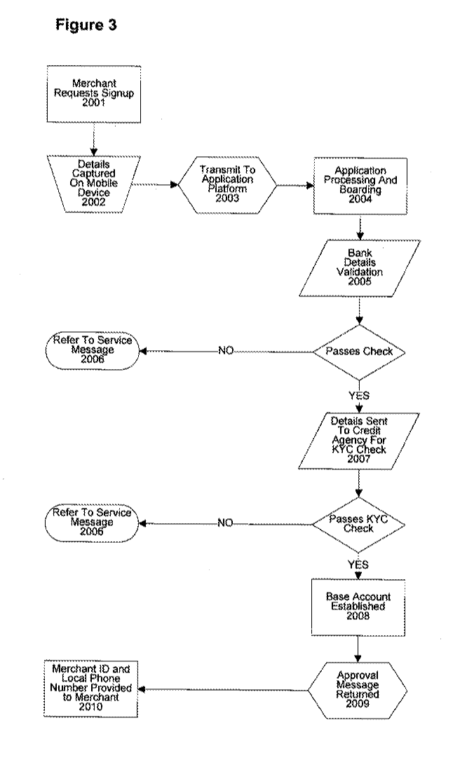

FIGS. 3 to 5 show various processes.

FIG. 3 shows a merchant's sign up or boarding process enabling a merchant to register with the system.

The boarding process is used to sign up merchants to be able to accept payments. This process is an optimization of the sign up process for a traditional merchant acquiring account and allows rapid boarding (signing-up) as no traditional credit card terminal device, NFC (near field communication) device or smart phone application are required.

Through a face-to-face or on-line sales process, the merchant requests the ability to accept payments by credit cards from consumers.

Merchant details are captured electronically through the use of a custom software application running on a web browser or tablet device.

The merchants' details are transmitted using traditional TCP/IP or wireless data services to the payment platform for processing.

A series of checks are made on the data for completeness. Instant feedback to the applicant is given if the application fails basic validation checks.

Bank details are validated through a third party validation service to ensure that the account is valid and can accept electronic funds transfers.

Accounts that fail validation are referred to a customer service group who contacts the merchant to assist in resolving the issues with the application.

Third party identity validation and credit scoring services are accessed to verify the identity of the merchant. A KYC (Know Your Customer) check may be done.

If merchant passes verification checks the merchant's base account is established on the payment platform and a unique merchant identifier is issued.

Upon approval a message is returned to the to the mobile device containing the approval message and the unique merchant ID.

Merchants are provided with their unique merchant ID and a local or other phone number that customers call to initiate payment transactions. They may also be provided with one or more signs, bearing their ID and other information to display at their permanent or temporary place of business.

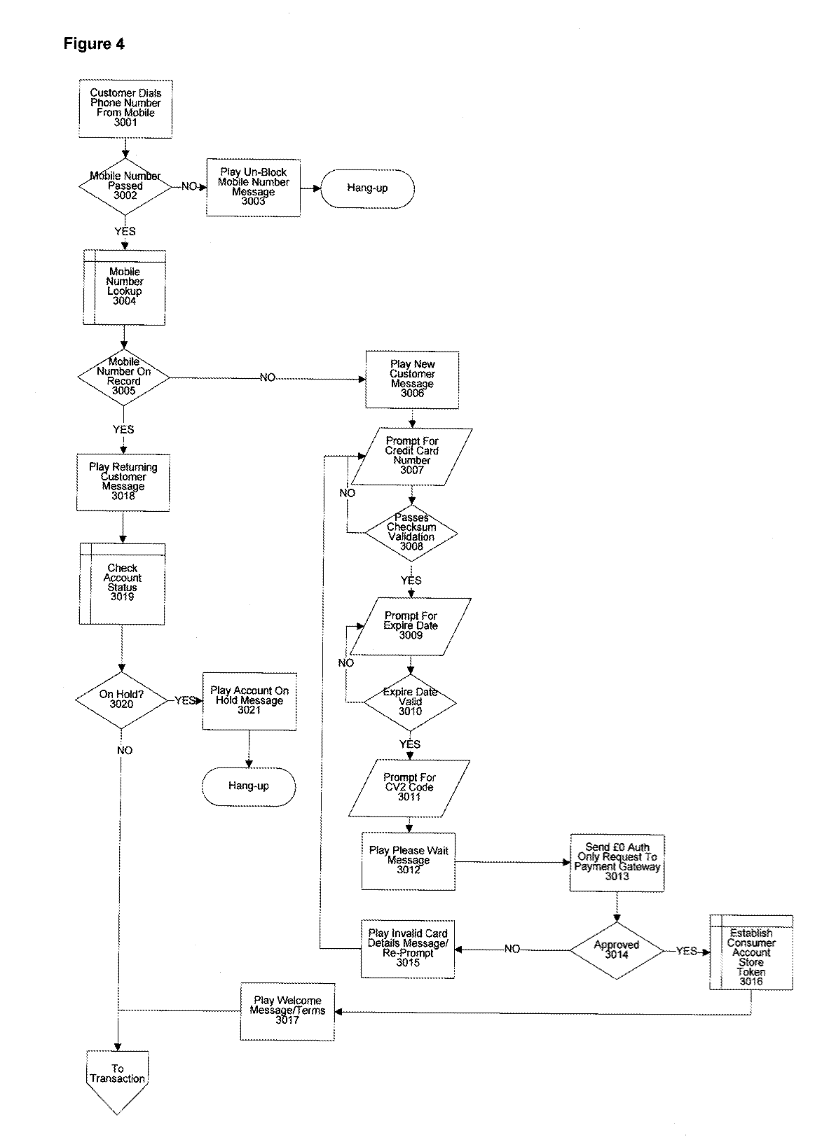

FIG. 4 shows a process by which customers first register. Generally, this will be done when the customer first buys goods or a service from a merchant although it may be done prior to this.

An IVR (Interactive Voice Response) system allows consumers to initiate secure payment transactions by using touch tone or voice recognition commands to interact with the payment platform.

The merchant provides the consumer with their merchant identification number and local or other telephone number to call to initiate a payment transaction. The consumer calls the payment platform from their mobile telephone.

The payment platform 1 accepts the call from the consumer and reads the mobile number passed by the telephone provider in the telephone call setup information.

If no CLI (calling line identifier) information is passed, this typically means that the consumer has blocked passing of their mobile number. The payment platform plays an audio message to the caller advising them that they must enable passing of the mobile number to utilize the service. This a first level security measure to validate the caller.

The payment platform queries the database of accounts for the mobile number.

If the mobile number is registered, processing passes to the returning customer message; control is passed to [3018]. If the mobile number is NOT registered, processing continues to the New Customer registration message; control is passed to [3006].

The new customer message provides details on card types accepted, terms and conditions and the registration steps.

The IVR prompts the user to enter their credit card number.

After capturing the digits a LUHN check (using the ‘Luhn’ algorithm) is performed on the credit card to determine if the card number was keyed in correctly and to verify that it is, for example, a MasterCard or Visa branded card. Other validations may be used. If validations fail, the consumer is re-prompted for the credit card number; control is passed to [3007]. The system allows, for example, three attempts and then refers the consumer to a help line and disconnects.

The IVR may prompt the user to enter the two digit month and two digit year of the cards expiry date using the touch tone keypad.

After capturing the digits a check is performed on the date entered to ensure that it is in a valid format that that the card has not expired. If validations fail, the consumer is re-prompted to enter the expiry date; control is passed to [3009]. The system allows, for example, three attempts and then refers the consumer to a help line and disconnects.

The IVR prompts the user to enter the three digit CV2 card verification code.

After capturing the CV2 a message is played to the consumer to wait for a few seconds while the card details are verified.

A zero value authorize only transaction is sent to the payment gateway via secure XML to confirm that the card details are valid.

The response from the payment gateway is analyzed. If the card details are not validated control is passed to [3015]. If the card details are validated control is passed to [3016].

A message is played to the consumer advising them that their card details were not validated. They are provided with an option to re-enter the details, to provide details for a different card, or to contact customer service.

On successful validation of the consumer's details an account is established on the payment platform. The consumer mobile number, card issuer identifier, a unique token for the authorization provided by the card issuer, and the expire date of the credit card are stored on the platform. Credit card and CV2 data are not stored on the platform at any time.

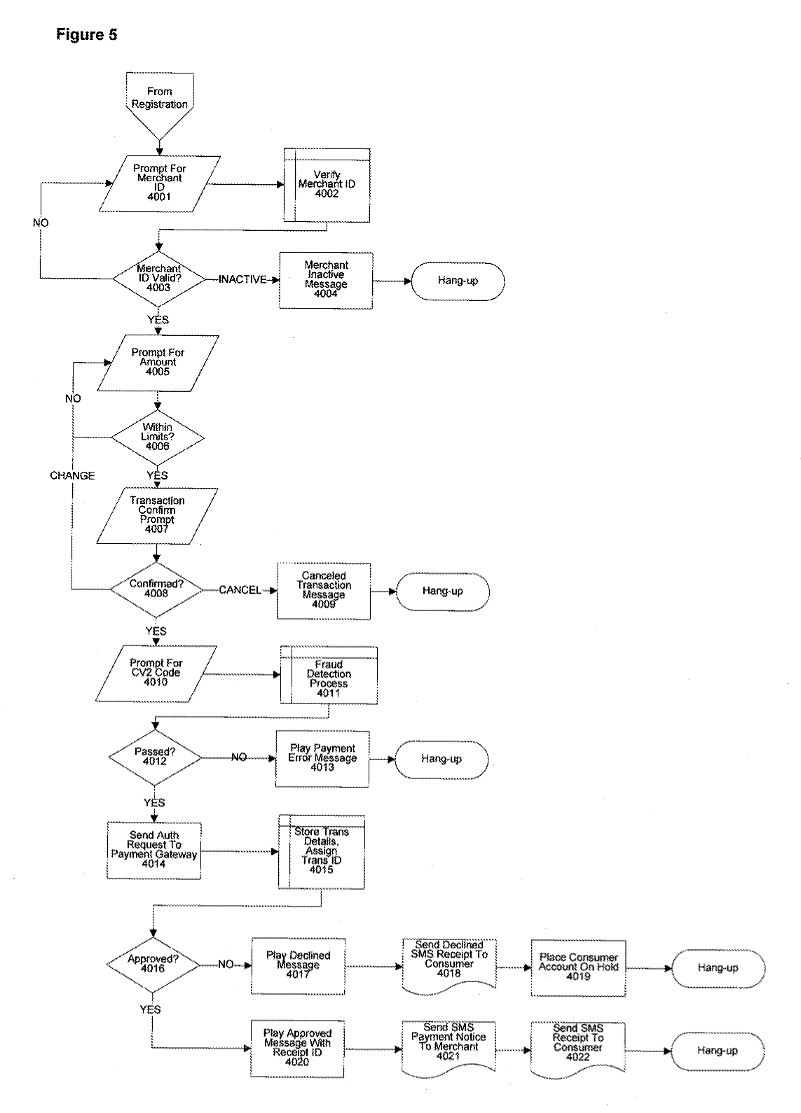

A welcome message and terms and conditions are played to the consumer. They are then transferred to a transaction process (see FIG. 5).

Returning consumers are played a returning customer greeting, instead of going to the sign-up stage [3006], etc

The consumer details are looked up in the processing platform and a check is made to verify account status and transaction limits.

If the consumer's account is on hold or they have exceeded transaction limits control is passed to [3021]. Accounts in good standing move to the transaction process (see FIG. 5).

A message giving details of the reason for the hold is played and the consumer is referred to customer service. The call is disconnected.

FIG. 5 shows a transaction process after a customer is registered.

Following consumer registration or account validation a standard process is followed to process a payment transaction. An example is as follows.

The IVR prompts the consumer to enter the merchant ID number.

The merchant ID is passed to the payment platform for validation. The system validates that the merchant ID passed is valid and that the merchant account is active.

If validations fail, the consumer is re-prompted for the merchant ID; control is passed to [4001]. The system allows three attempts and then refers the consumer to a help line and disconnects.

If the merchant is no longer active on the system, the consumer is played a message that payment cannot be taken for this merchant and the call is disconnected.

The IVR prompts the consumer to enter the amount of the sale.

The amount is validated against both the consumer and merchant profile to ensure that it falls with transaction, daily and weekly volume limits based on the consumer and merchants history. If the amount falls outside of the limits, a message is played to the consumer advising them of the exceeded limit. The consumer is given the option of entering a lower amount to continue with the transaction; control is passed to [4005]. The system allows three attempts and then refers the consumer to a help line and disconnects.

The merchant name and amount is played back to the consumer for verification. The consumer can press 1 to verify, 2 to change or 3 to cancel, for example.

If the consumer confirms control is passed to [4010]. If the consumer requests a change the control is passed to [4005]. If the consumer requests to cancel the transaction control is passed to [4009].

A message is played to the consumer that the transaction has been cancelled and their card has not been charged then disconnects.

The consumer is prompted to enter the CV2 credit card security code from the back of the card. This value must always be provided by the consumer as a security measure to prevent fraudulent use of the payment platform in the event the consumers' mobile phone is stolen.

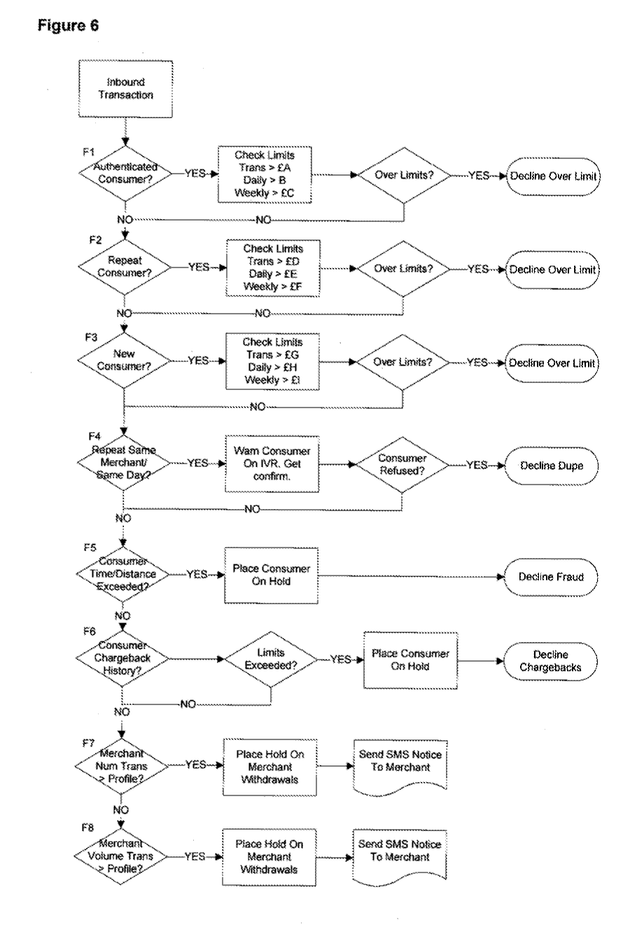

After capturing the CV2 code the system performs a fraud detection process (see FIG. 6).

If the fraud detection process fails control is passed to [4013]. If the fraud detection process passes control is passed to [4014].

A message is played to the consumer that the transaction cannot be processed. The reason for the exception is given and the consumer is directed to customer service. The call is disconnected.

The transaction details, CV2 code and amount are sent to the payment gateway 15 (see FIG. 2) by secure XML for authorization.

The transaction details and response from the payment gateway are stored by the payment platform.

If the transaction is not approved control passes to [4017]. If the transaction is approved control passes to [4020].

A message is played to the consumer explaining the transaction was declined. The call is disconnected.

An SMS message is sent to the consumers mobile device with the reason for the decline.

The customer account is placed on hold and referred to customer service for review.

A message is played to the consumer that the transaction was approved and providing a numeric receipt ID. The call is disconnected.

An SMS (Short Message Service) message is sent to the merchants mobile device with the approval and receipt ID.

An SMS message is sent to the consumer's mobile device with the approval and receipt ID.

Of course, other types of notification than SMS messages may be sent to the merchant and/or consumer.

FIG. 6 shows a fraud detection process.

Each transaction is analyzed for fraudulent activity to mitigate risk. The payment processing system builds a profile on the merchant and consumer. Key fraud controls include, for example:
Length of time account has been established.
Number of transactions processed.
Value of transactions on an individual, daily and weekly basis.
Geolocation distance between transaction locations during a time period.
History of disputed transactions.
Merchant average transaction value.
Merchant average transaction frequency.

Accounts that are detected by the Fraud system either have individual transactions declined or are automatically placed on an administrative hold and referred to a customer service team for review.

Merchants on administrative hold are able to accept payments however the account is locked from settling funds.

In the figures, tests include authentication of customer F₁, whether the customer is a repeat customer F₂ or new customer F₃, whether the customer has made a repeat transaction the same day (or within a limited period), with the same merchant F₄, or a group of merchants, for example, whether a series of transactions which have been made at different locations are possible by the same person (eg if two transactions are made from London and Birmingham within 5 minutes it is unlikely the same person has made them!) and others. Financial limits, such as individual transaction limits, daily, weekly limits and so on, can also be checked.

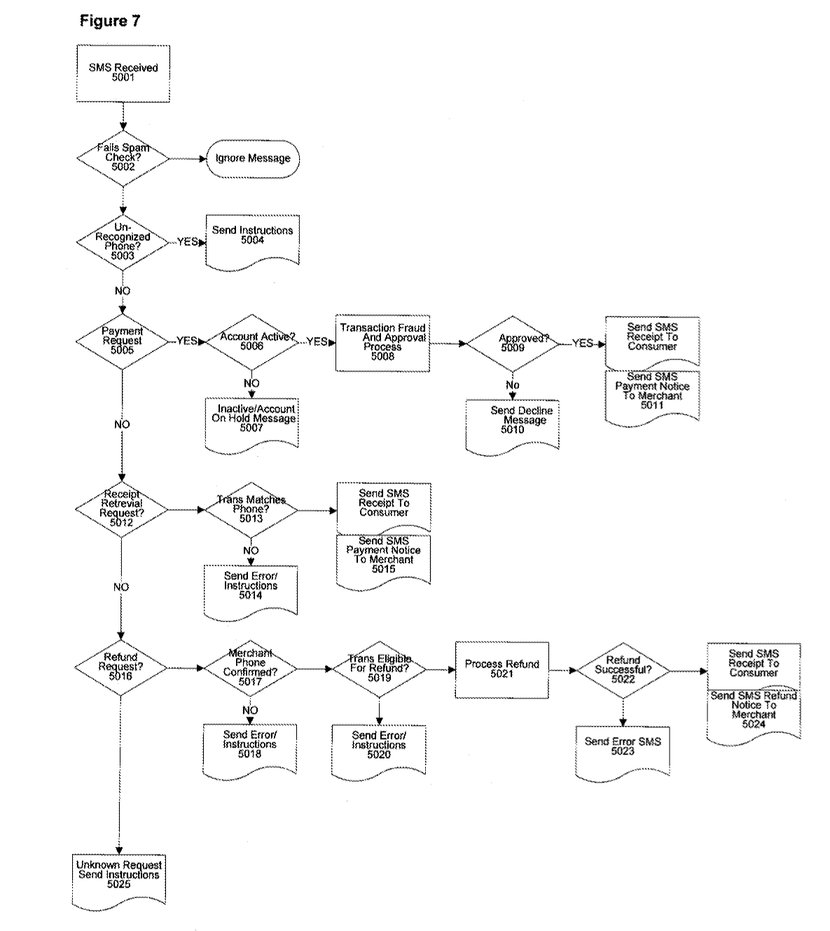

FIG. 7 shows an SMS based process.

Merchants and consumers can interface with the system using SMS messages as an alternative to IVR interaction to perform purchase, verification and refund transactions.

Consumers that have pre-registered through the IVR interface can send an SMS message to the payment platform containing the merchant ID, amount and CV2 code separated with hash symbols to initiate a payment transaction.

Merchants can reply to payment receipt SMS messages with a REFUND authorization to refund transactions. Merchants can query payment receipt numbers provided by consumers to ensure that they are valid and have been authorized against their account.

An SMS message is received by the payment platform.

The message phone number is compared to a carrier list to ensure that it has originated from the senders phone and not through an SMS gateway.

The originating mobile phone number is looked up in the payment management system 1 to see if it a recognized merchant or consumer account. If it is not recognized control passes to [5004]. If the account is valid, control passes to [5005].

If the account is invalid (or not set-up yet) an SMS message is sent to the sending mobile number indicating that their phone number is not recognized and providing instructions to call the IVR platform.

The format of the message is analyzed to determine if it is a payment request. If it is a payment request control passes to [5006]. If it is not a payment request control passes to [5012].

A check is made to determine if the consumer account is active and in good standing. If the account is on hold or inactive control passes to [5007]. If the account is active control passes to [5008].

An SMS message is sent to the sending mobile number indicating that the account is on hold and referring the consumer to customer service.

Fraud and account limit checks are performed on the request (see FIG. 5 IVR transaction process and FIG. 6 fraud detection process for detail). The transaction is then sent to the payment gateway for authorisation.

If the transaction fails the fraud checks or is declined control passes to [5010]. If the transaction is approved control passes to [5011].

An SMS message is sent to the sending mobile number indicating that the transaction has been declined and referring the consumer to customer service.

An SMS message is sent to the consumer with the approval and a receipt ID. An SMS message is sent to the merchant's mobile device with the approval and receipt ID.

The format of the message is analyzed to determine if it is a receipt request. If it is a receipt request control passes to [5013]. If it is not a receipt request control passes to [5016].

A check is made to ensure that the phone number requesting a receipt copy is registered to either the merchant or CONSUMER involved in the transaction. If the phone number requesting the receipt is not involved control passes to [5014]. If it is involved control passes to [5015].

An SMS message is sent to the sending mobile number indicating that there is an error in the receipt number and referring them to customer service.

The transaction details are retrieved from the payment platform. An SMS message is sent to the consumer and merchant containing the receipt and transaction information.

The format of the message is analyzed to determine if it is a refund request. If it is a refund request control passes to [5017]. If it is not a refund request control passes to [5025].

A check is made to ensure that the phone number requesting a refund copy is registered to the merchant involved in the transaction. If the phone number requesting the receipt is not the merchant control passes to [5018]. If it is involved control passes to [5019].

An SMS message is sent to the sending mobile number indicating that there is an error in the refund request and refers them to customer service.

The transaction details are retrieved from the payment platform and checked to see if it is eligible for a refund based on prior refunds, time since the transaction was processed and fraud checks. If the transaction is not eligible for refund control passes to [5020] If the transaction is eligible for refund control passes to [5021].

An SMS message is sent to the merchant indicating that the transaction is not eligible for refund and refers them to customer service.

The payment processing platform sends the refund transaction to the payment gateway for processing.

If the refund is not successful control is passed to [5023]. If the refund is successful control is passed to [5024].

An SMS message is sent to the merchant indicating that the refund transaction failed and refers them to customer service.

An SMS message is sent to the consumer and merchant containing the receipt for the refund.

If the format of the SMS request is not recognized an SMS message is sent to the sending mobile number with a list of available options and customer service contact information.

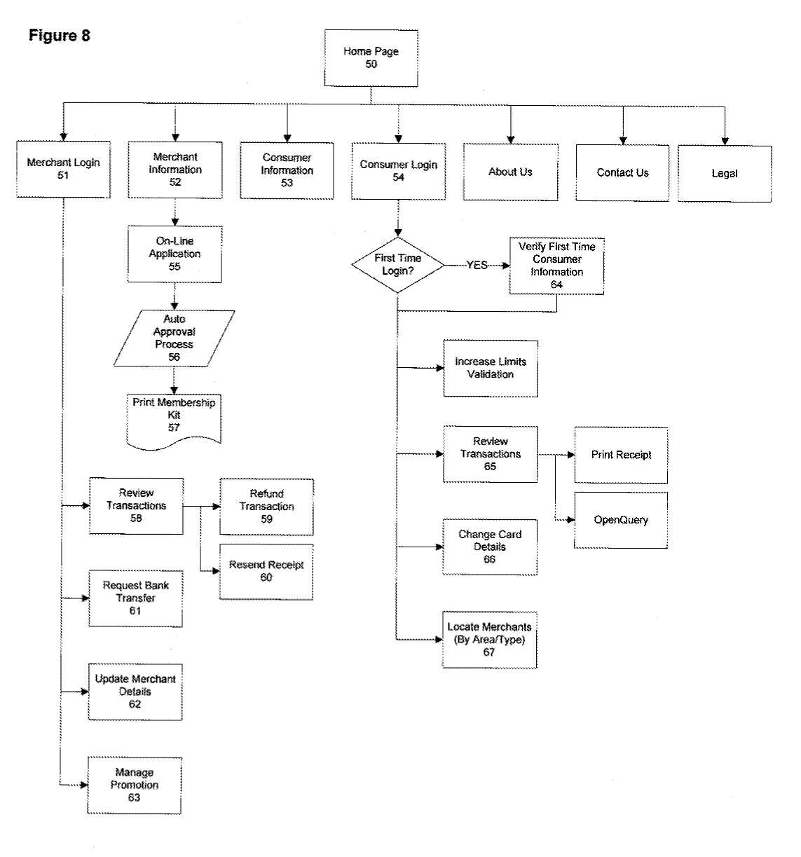

FIG. 8 shows the web interface 11 of FIG. 2. This can be used to provide information on the service and enables both consumers and merchants to review, maintain and service their account information by accessing over the Internet either from their home PC, or a mobile device or indeed from their telephone or other device, the consumer and merchant can view different information. They will first view a home page 50 which then gives them several options such as the merchant login 51, a merchant information screen 52, consumer information 53, consumer login 54 and various screens such as ‘About Us’ and ‘Contact Us’ and legal. A merchant, viewing the merchant information page, may be able to make an online application for approval 55 and to then go through an approvals process 56 and perhaps also to print a membership kit 57. Alternatively, a merchant once registered with the system may be able to log on via a login screen 51 and to review his transactions 58, conduct refunds 59 or ask for receipts to be resent 60, request a bank transfer 61, update details of the merchant such as address, banking details or otherwise 62 or manage various promotions 63. A consumer may be able to login at a login screen 54 and either verify first time login information via system generated code delivered by SMS 64 or conduct various actions such as increasing transaction limits (either for a single purchase or daily, weekly limits, or so on) and perhaps these limits might be increased if the user provides more personal information. The user can also review transactions 65, print receipts or ask queries, change card details 66 or locate various merchants in various areas 67.

It is thus seen that in embodiments of the invention the user does not need to give his personal information such as his name, address or otherwise to the merchant. It may be that if he wishes to increase his account limit (eg the amount he can spend in any transaction) (63 in FIG. 8) he is required to give name and address information which might help to further identify the user and give a higher level of security for higher account limits, but for basic use the user generally will not need to give such information.

Note also, from FIG. 4, that although credit card information is input when the customer first registers (or first makes a transaction) this card information passes directly to the bank or other financial institutions and is not generally retained by the payment management system 6. Instead, a token 3016 (FIG. 4) is passed from the financial institution to the system and this token is used to validate transactions. Thus, for transactions after a user has been registered, once the system recognises the mobile phone number and the user enters their password (which will generally be the simple CV2 or CVV number available on any credit card) the system checks this against the token and does not maintain or need to access details of the actual credit card number itself, thus increasing security and sense of wellbeing of the customer.

Thus, the first time a customer or consumer wishes to make a transaction needing the system he has to enter his credit or other bank card number. However, on each further occasion he does not need to enter this number and this number is never available to the merchant.

While in many embodiments a very basic mobile telephone can be used by both the consumer and/or the merchant, requiring only basic voice, touchtone and/or SMS facilities, in other embodiments the system may be embodied as a smart phone application such as an iPhone™ ‘app’. Such an app may be used by the merchant and/or by the consumer and may include means for specifically requesting the various bits of information required and for transmitting these directly to the payment management system. The ‘app’ may then be used by the consumer or merchant as a record of all their transactions and may include details of these (why without confidential information being displayed if appropriate) and can be a convenient method for the merchant and/or consumer to manage the system.

1. A transaction system comprising a payment platform provided on a network, the platform comprising; means for transmitting data to and from a plurality of merchant-side terminals; means for transmitting data to and from a plurality of customer-side terminals; and means for providing data to and from one or more financial institutions; wherein each merchant is associated with a unique reference and comprising means for a customer mobile telephone number, a password and a merchant unique reference to be input to the service provider from a merchant terminal and/or a customer terminal and, if the mobile number is logged against a source of funds provided by one or more of the financial institutions, enabling a transaction to be authorised and money transferred from the financial institution to the merchant.

2. A transaction system as claimed in claim 1, including a mobile interface adapted to provide an interface between the service provider system and the customer and merchant.

3. A transaction system as claimed in claim 1, including a payment gateway adapted to enable the payment system to communicate with one or more financial institutions.

4. A transaction system as claimed in claim 1, comprising means for storing a token representative of a customer's authorisation and/or approval stored at the payment platform system and associated with, at least, a customer's mobile telephone number and merchant identification number, means for checking if an appropriate token exists when the mobile telephone number and merchant identification are transmitted from the customer or merchant device to the system.

5. A system as claimed in claim 4, including means for enabling a password to be entered by a customer whereby, if the customer is seen to be authorised and the password is correct, the transaction is authorised.

6. A system as claimed in claim 4, wherein the customer telephone number and merchant ID may be transmitted from a customer device and/or from a merchant device.

7. A system as claimed in claim 1, wherein specific details of a client's account at a financial institution are not stored within the remote payment system.

8. A system as claimed in claim 1, the payment system including means for identifying, when a customer accesses the system via a mobile device, whether the customer is already authorised to make transactions.

9. A system as claimed in claim 1, including means for enabling the customer to board the system if he is not already authorised to make transactions.

10. A system as claimed in claim 1, wherein data is entered using an interactive voice response (IVR) mechanism.

11. A method for conducting transactions between any one of a plurality of merchants and any one of a plurality of customers, comprising, at a payment system remote from the merchants and customers, storing data related to a customer against a record relating to a customer's mobile telephone number and enabling a transaction to be completed upon recognition of said telephone number and input of password, payment amount and a unique identifier for the merchant to thereby enable said transaction.

12. A method as claimed in claim 11, wherein, once a customer is authorised to a system, a token is stored at the payment system representative of each authorised customer and during each subsequent transaction, this is checked against entry of the customer's mobile device number and the merchant ID number to authorise the transaction.

13. A method as claimed in claim 12, wherein a password is also required to be entered to authorise a transaction.

14. A method as claimed in claim 13, wherein the password is a CV2 or CVV number.

15. A method as claimed in claim 14, wherein subsequently to a customer registering, neither the merchant nor the payment management system stores a customer's credit card or other financial account number.

16. A method as claimed in claim 11, including one or more fraud prevention steps.

17. A method as claimed in claim 11, wherein the merchant is a market trader or other mobile or small value trader.

18. A transaction system comprising a plurality of merchant devices, a plurality of customer devices and a central payment system, whereby any of the customers can conduct financial transactions with any of the merchants by means of, after an initial registration, entry of a unique ID associated with the merchant, password, payment amount and system recognition of the customer's mobile phone number (CLI).
